(19) United States
(12) Patent Application Publication
(10) Pub. No.: US 2013/0164498 A1
(43) Pub. Date: Jun. 27, 2013

(54) THERMOPLASTIC COMPOSITE PREPREG FOR AUTOMATED FIBER PLACEMENT

(71) Applicant: ADC ACQUISITION COMPANY, Shenectady, NY (US)

(72) Inventors: Robert J. Langone, Clifton Park, NY (US); David E. Hauber, Troy, NY (US); Zachary A. August, Clifton Park, NY (US)

(73) Assignee: ADC ACQUISITION COMPANY, Schenectady, NY (US)

(21) Appl. No.: 13/718,192

(22) Filed: Dec. 18, 2012

Related U.S. Application Data
(60) Provisional application No. 61/578,386, filed on Dec. 21, 2011.

(51) Int. Cl. B32B 5/28

(52) U.S. Cl. CPC B32B 5/28
USPC 428/141; 428/411.1; 428/688; 428/446; 428/523; 428/473.5; 428/337; 428/221

(57) ABSTRACT

An improved thermoplastic composite prepreg tape is disclosed. The prepreg tape is optimized for high-speed, high quality in-situ consolidation during automated fiber placement. Embodiments of the prepreg tape have uniform dimensions (cross section, width, and thickness), uniform energy absorption, uniform surface roughness, and sufficient resin at the surface to affect a bond between layers.

### CROSS REFERENCE TO RELATED APPLICATIONS

This application claims priority to 61/578,386 filed on Dec. 21, 2011, and is incorporated herein by reference.

### FIELD OF THE INVENTION

The present invention relates generally to composite materials, and, more particularly, to an improved thermoplastic composite prepreg for automated fiber placement.

### BACKGROUND

Reinforced thermoplastic and thermoset materials have wide application in, for example, the aerospace, automotive, industrial/chemical, and sporting goods industries, etc. Thermoplastic or thermosetting resins are impregnated into reinforcing fibers to form a “prepreg” tape that is used to form completed structures. Thermoplastic prepregs may be melt bonded together in-process avoiding the expensive and time-consuming procedure of curing that is required for thermoset prepregs. These thermoplastic prepreg tapes are growing in popularity among all segments of the composites industry due to their higher performance and versatility. However, process rates, surface finish, and some properties such as void content are lower for in-process consolidated thermoplastic prepregs. It is therefore desirable to have an improved thermoplastic composite prepreg for automated fiber placement.

### SUMMARY

Embodiments of the present invention provide an improved thermoplastic composite prepreg for automated fiber placement. The prepreg in accordance with an embodiment of the present invention has a substantially uniform geometry. In some embodiments, a susceptor layer is disposed on a composite tape. A resin layer is disposed over the susceptor, and the susceptor absorbs energy, for example, from electromagnetic waves, such as light from a laser, or ultrasonic energy from an ultrasonic energy source. It will be recognized that any and all feasible energy sources are included within the scope of the invention. The susceptor then heats up the resin which allows for more effective formation of multilayer composite shapes. Methods in accordance with embodiments of the present invention create structures using this prepreg without the need for costly and time-consuming autoclave processes.

In one embodiment, a multilayered composite material is provided, the material comprising, a fiber tape comprising fibers held together with a thermoplastic polymer matrix, a susceptor layer disposed on a first side of the fiber tape, and a polymer surface layer disposed on the susceptor layer.

In another embodiment, a multilayered composite material is provided, the material comprising, a fiber tape comprising fibers held together with a thermoplastic polymer matrix, a polymer surface layer disposed on the fiber tape, wherein a susceptor is intermixed in the polymer surface layer.

In another embodiment, a multilayered composite material is provided, the material comprising, a fiber tape comprising fibers held together with a thermoplastic polymer matrix, a first susceptor layer disposed on a first side of the fiber tape, a first polymer surface layer disposed on the first susceptor layer, a second susceptor layer disposed on a second side of the fiber tape, and a second polymer surface layer disposed on the second susceptor layer.

### BRIEF DESCRIPTION OF THE DRAWINGS

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering may represent like elements.

FIG. 1 shows a prior art prepreg tape with a non-uniform geometry.

FIG. 2 shows a prior art prepreg tape with uneven resin distribution.

FIG. 3 shows a block diagram of the process of application of a prepreg tape.

FIG. 4A is a block diagram of a prepreg tape in accordance with an embodiment of the present invention.

FIG. 4B is a block diagram of a prepreg tape in accordance with an alternative embodiment of the present invention.

FIG. 5 shows multiple layers of a prepreg tape in accordance with an embodiment of the present invention.

FIG. 6 is a block diagram of a prepreg tape in accordance with an alternative embodiment of the present invention.

### DETAILED DESCRIPTION

Embodiments of the present invention provide an improved thermoplastic composite prepreg tape. The prepreg tape is optimized for high-speed, high quality in-situ consolidation during automated fiber placement. Embodiments of the prepreg tape have substantially uniform dimensions (cross section, width and thickness, etc.), substantially uniform energy absorption, substantially uniform surface roughness, and sufficient resin at the surface to affect a bond between layers. Embodiments of the present invention provide a multilayered composite material. The multilayered composite material comprises a fiber tape comprising: fibers held together with a thermoplastic polymer matrix; a susceptor layer disposed on at least one side of the fiber tape; and a polymer surface layer disposed on the susceptor layer. Benefits include being able to fabricate components (e.g. aircraft parts and the like) using automated fiber placement without the need for costly and time-consuming post processes such as an autoclave.

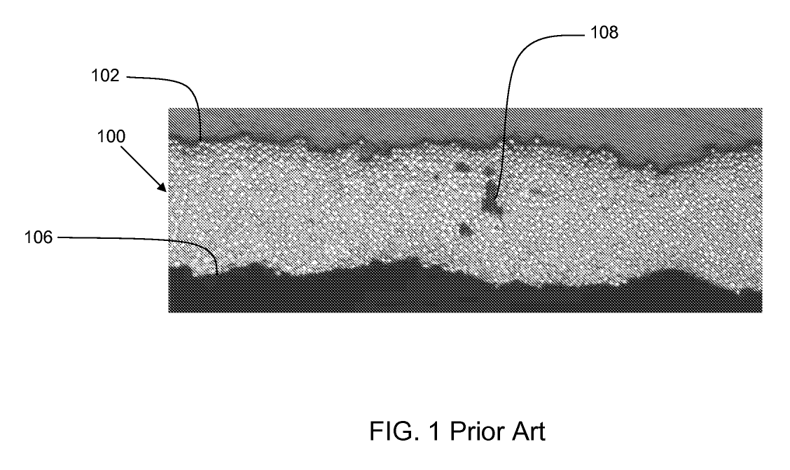

FIG. 1 shows a prior art prepreg tape 100 with a non-uniform geometry. As can be seen in FIG. 1, the top edge 102 of the tape 100 and bottom edge 106 of the tape are relatively non-uniform (uneven). The non-uniform surface of prepreg tape 100 necessitates that the tape be heated through the thickness so that it will conform to the previous ply to form a good bond. Furthermore, one or more voids 108 may be present in the tape 100. The presence of voids such as 108 may require significant time under pressure and temperature for the entrapped air to diffuse. Therefore, a prepreg tape of this nature may not be economical for in-situ Automated Fiber Placement (AFP).

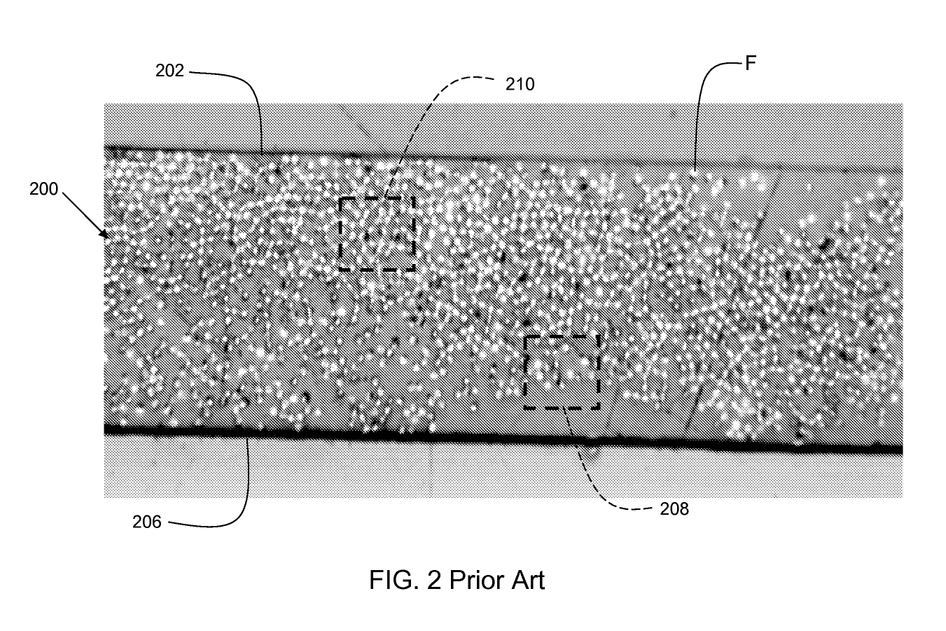

FIG. 2 shows a prior art prepreg tape 200 with uneven resin distribution. The top edge 202 of the tape 200 and bottom edge 206 of the tape are relatively smooth, compared with that of tape 100 of FIG. 1. The composite fibers within tape 200 appear as white dots, denoted generally as “F.” Tape 200 has a relatively uneven fiber distribution. For example, cross-sectional region 208 has relatively few fibers as compared with similarly sized cross-sectional region 210. For a given cross-sectional region, it is desirable to have a relatively consistent fiber density. The non-uniform distribution of the fibers of tape 200 can result in uneven heating, which can further result in structural defects or increased process time for preventing such defects.

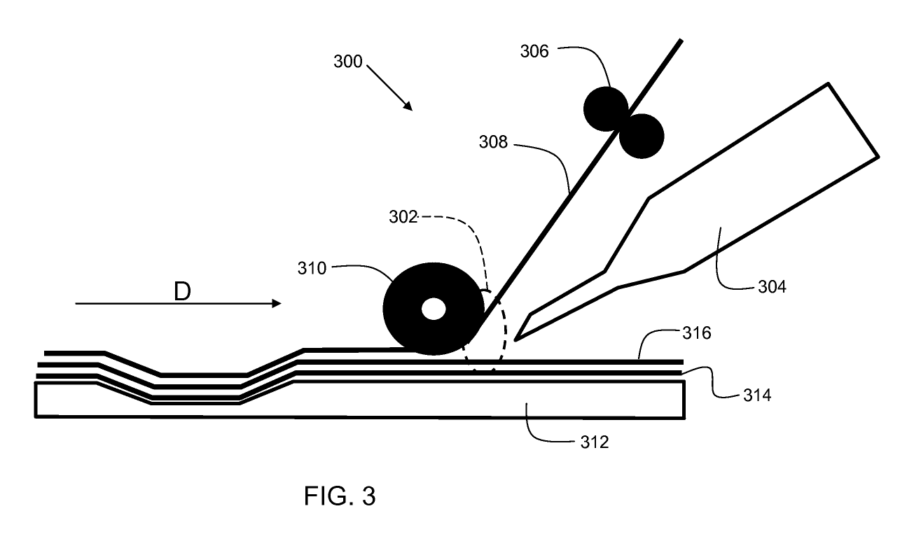

FIG. 3 shows a block diagram 300 of the application of a prepreg tape in an automated fiber process (AFP). Fiber tapes are placed over a tool 312 to form a desired component shape. As shown in FIG. 3, tape 314 and tape 316 have been previously applied. Tape 308 is currently being applied. A heat source 304 applies heat to the currently applied tape 308 as it is dispensed from tape feed 306, and also applies heat to the previously applied tape 316. The heat source 304 may be a laser or any other suitable device or means. The area where heat is applied is referred to as a Heat Affected Zone (HAZ) 302. The HAZ raises both the currently applied tape 308 and the previously applied tape 316 to a temperature suitable to affect a bond between the layers. Currently applied tape 308 is then pressed against previously applied tape 316 by compaction roller 310, causing a bond to form between tape 308 and tape 316.

The larger the HAZ, the more time it takes to cool and the more residual stresses are induced. The prepreg shrinks as it cools due to its Coefficient of Thermal Expansion (CTE) at varying rates depending on factors, non-limiting examples of which include the type of fiber, matrix, and the direction (e.g. fiber direction or cross-fiber direction) in which shrinkage is measured. The currently applied tape 308, heat source 304, and associated tape supply mechanism travel in direction D to apply the tape. In some embodiments, this motion may be repeated as necessary or desirable to build up a composite shape.

One way to achieve a small HAZ 302 is to use a high intensity energy source such as a laser. If the laser energy is of a wavelength that is absorbed by the polymer (such as CO₂ lasers at 10.6 μm), then the high intensities that are needed for high process rates tend to vaporize or otherwise damage the polymer on the surface resulting in poor bond quality. Therefore, with the non-uniform fiber distribution and/or surfaces of the prior art prepreg tapes, uneven heating and poor bond quality can result. If the laser energy is of a wavelength to which the polymer is transparent (such as, for example, diode lasers or fiber lasers at 1060 nm) then an absorbing material is needed to create the HAZ.

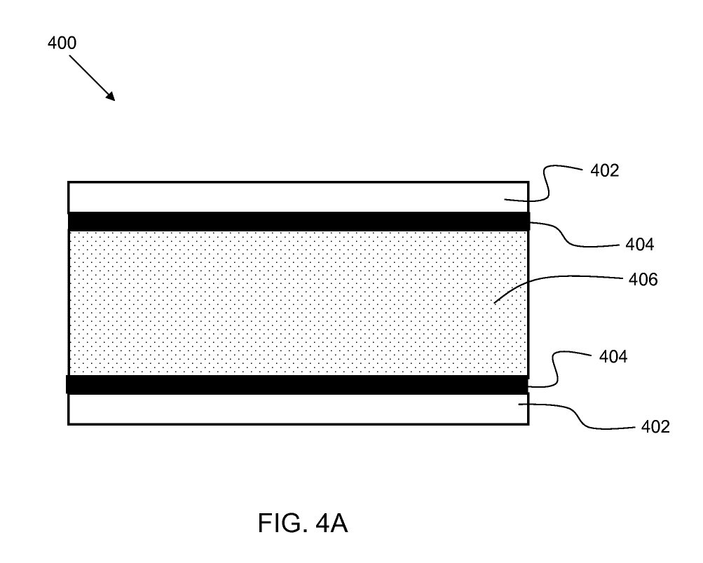

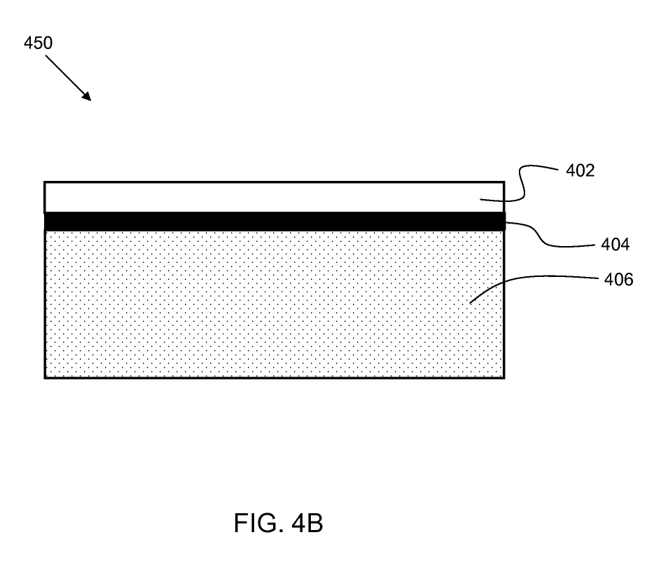

FIG. 4A is a block diagram of a prepreg tape 400 in accordance with an embodiment of the present invention. The prepreg tape 400 comprises fiber tape 406, which is a tape comprised of reinforcement fibers held together by a thermoplastic polymer matrix. In one embodiment, the fiber tape 406 is comprised of carbon fibers in resin. In one embodiment, the resin is comprised of PEEK (Polyether ether ketone). In other embodiments, the resin may comprise virtually any thermoplastic resin including without limitation: PEKK (polyetherketoneketone), PEK (polyetherketone), PAEK (Polyarlyetherketone), PPS (Polyphenylene Sulfide), PI (Polyimide), TPI (Thermoplastic Polyimide), PEI (Polyetherimide), PP (Polypropylene), PE (Polyethylene), PBT (Polybutylene Terephthalate), FEP (Fluorinated Ethylene Propylene), PFA (Perfluoroalkoxy), PVDF (Polyvinylidene floride), TFE (Polytetrafluoroethylene), ETFE (Poly(Ethylene Tetrafluoroethylene)), PET (Polyethylene Terephthalate), TPU (Thermoplastic Polyurethane), PA (Polyamide), PAI (Polyamide-Imide), PBT (Polybutylene Terephthalate), or any combination thereof. In other embodiments, the fiber tape 406 may have fibers comprised of glass, ceramic, aramid, any combination thereof, or any other material that has high strength, stiffness, energy absorption, or any other desirable property. In one embodiment, the carbon fibers have a diameter ranging from approximately 6 micrometers to approximately 8 micrometers. It will be recognized that any other feasible dimensions are included within the scope of the invention. The fibers of tape 406 may be continuous fibers, woven fibers, braided fibers, discontinuous fibers, fiber mat, any combination thereof, or any other suitable form. The fiber tape 406 may have a thickness ranging from approximately 130 micrometers to approximately 150 micrometers. It will be recognized that any other feasible thicknesses are included within the scope of the invention. In one embodiment, the fibers of tape 406 are continuous unidirectional fibers. It will be recognized that any other feasible fiber arrangements are included within the scope of the invention. A susceptor (absorber) layer 404 is disposed on each side the fiber tape 406. A polymer surface layer 402 is disposed on each of the susceptor layers 404.

The susceptor layer 404 absorbs the energy from a laser or other source to create the heat needed to bond adjacent layers of the prepreg tape 400. The choice of material for the susceptor may depend, in part, on the energy source used for creating the HAZ. For example, if laser energy at 1060 nm is used, the absorber 404 may be comprised of carbon black, nanotubes, nanoclay, graphene, nanoparticles, whiskers, carbon fiber dust, or any other suitable means. CLEARWELD coating (Produced by Gentex, Carbondale, Pa.) may also be used, as it contains energy absorbing materials designed for operating in the 940 nm-1100 nm wavelength range. Clearweld coatings form thin, uniform layers of the energy absorbing materials onto the fiber tape 406. When laser energy is applied to the area that has been coated, the Clearweld material absorbs this energy and converts it to heat. This results in a localized melting of the prepreg tape layers and the formation of a weld.

A variety of methods may be used for making polymer surface layer 402. Such methods may include, but are not limited to, extrusion, film coating, powder coating, casting, solution coating, plasma spray, flame spray, sintering, vapor deposition, any combination thereof, or any other suitable means. In one embodiment, the polymer surface layer 402 has a thickness ranging from approximately 1 micrometer to approximately 15 micrometers, and a surface roughness, Ra, ranging from approximately 0.1 micrometers to approximately 1.3 micrometers. It will be recognized that any other feasible thicknesses and surface roughnesses are included within the scope of the invention. The polymer surface layer may be comprised of PE (Polyethylene), PP (Polypropylene), PET (Polyethylene terephthalate), PEEK (Polyether ether ketone), PEKK (Polyetherketoneketone), PI (Polyimide), PAI (Polyamide-imide), any combination thereof, or any other suitable polymer.

It is preferable to provide a uniform coating that achieves intimate contact with the surface to which it is being bonded, and has sufficient thickness to affect the bond, but not so thick as to adversely affect the performance of the overall structure by significantly reducing fiber volume fraction. Since the fibers produce the desirable strength and/or stiffness in a typical composite structure, it is desirable to maximize the amount of fibers available per unit volume. This parameter is referred to as “fiber volume.”

FIG. 4B is a block diagram of a prepreg tape 450 in accordance with an embodiment of the present invention. Prepreg tape 450 is similar to prepreg tape 400 of FIG. 4A, except that prepreg tape 450 only has absorber 404 and polymer surface layer 402 on one side. This embodiment may be more economical for certain applications.

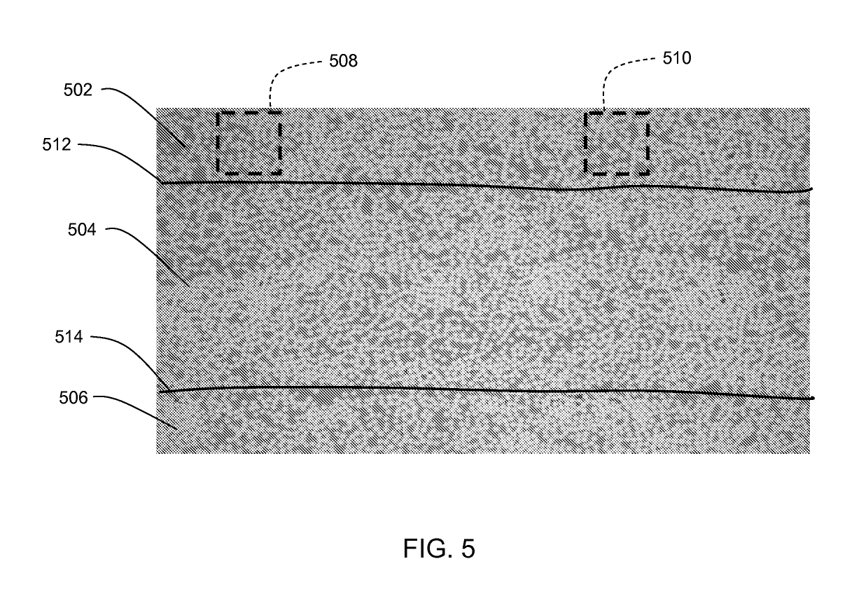

FIG. 5 shows multiple layers of a prepreg tape (such as 400 in FIG. 4A) bonded together in accordance with an embodiment of the present invention. Tape layer 502 is bonded to tape layer 504, which is in turn bonded to tape layer 506. The boundary 512 between tape layer 502 and tape layer 504 is substantially uniform, providing a good bonding surface. This also holds true for boundary 514 between tape layer 504 and tape layer 506. The fiber volume per unit area is relatively consistent. For example, the fiber volume in cross-sectional area 508 is similar to the fiber volume in cross sectional area 510.

In one embodiment, the fiber volume, which is a percentage of fiber volume to total volume for a given cross-sectional volume of the tape, ranges from 55% to 65% with one standard deviation ranging from about 2% to about 4%, and more preferably about 3%. It will be recognized that any other feasible fiber volumes are included within the scope of the invention.

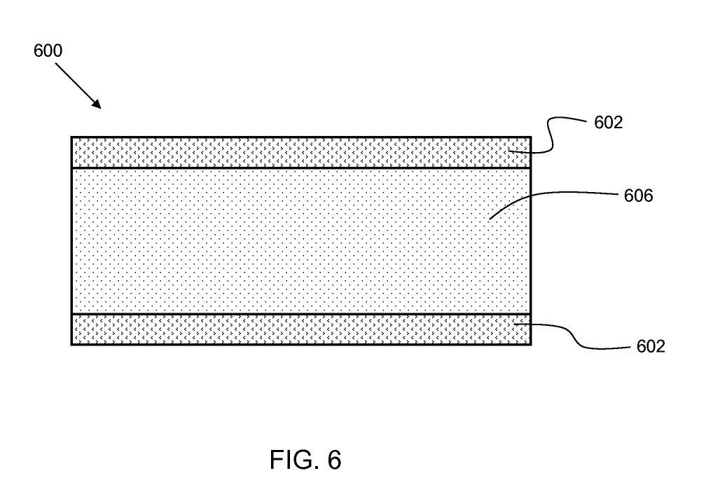

FIG. 6 is a block diagram of a prepreg tape 600 in accordance with an alternative embodiment of the present invention. In this embodiment, fiber tape 606 (which is similar to fiber tape 406 of FIG. 4A) has polymer surface layer 602 with a susceptor mixed into it. Hence, as compared with the embodiment of FIG. 4A, the susceptor here is intermixed in the polymer rich surface, not just under it. In this embodiment, the absorber is not concentrated at the surface of the prepreg as shown in the embodiment of FIG. 4A. As long as the susceptor is configured in such a way so as to provide uniform heating of the surface polymer layer, a bond is then able to form between layers without damage to the polymer or significant degradation of the physical properties of the laminate. In this embodiment, the susceptor may comprise carbon black, or any other suitable material that can be mixed with a polymer surface layer.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A multilayered composite material comprising:
a fiber tape comprising fibers held together with a thermoplastic polymer matrix;
a susceptor layer disposed on a first side of the fiber tape; and
a polymer surface layer disposed on the susceptor layer.

2. The material of claim 1, wherein the susceptor layer is comprised of carbon black.

3. The material of claim 1, wherein the susceptor layer is comprised of nanotubes.

4. The material of claim 1, wherein the susceptor layer is comprised of nanoclay.

5. The material of claim 1, wherein the susceptor layer is comprised of graphene.

6. The material of claim 1, wherein the susceptor layer is comprised of nanoparticles.

7. The material of claim 1, wherein the susceptor layer is comprised of carbon fiber dust.

8. The material of claim 1, wherein the polymer surface layer is comprised of polyethylene.

9. The material of claim 1, wherein the polymer surface layer is comprised of polypropylene.

10. The material of claim 1, wherein the polymer surface layer is comprised of polyether ether ketone.

11. The material of claim 1, wherein the polymer surface layer is comprised of polyetherketoneketone.

12. The material of claim 1, wherein the polymer surface layer is comprised of polyimide.

13. The material of claim 1, wherein the polymer surface layer has an average surface roughness ranging from about 0.1 micrometers to about 1.3 micrometers.

14. The material of claim 1, wherein the fiber tape has a fiber volume ranging from about 55% to about 65%.

15. The material of claim 14, wherein the fiber tape has a thickness ranging from about 130 micrometers to about 150 micrometers.

16. A multilayered composite material comprising:
a fiber tape comprising fibers held together with a thermoplastic polymer matrix;
a polymer surface layer disposed on the fiber tape, wherein a susceptor is intermixed in the polymer surface layer.

17. The material of claim 16, wherein the susceptor layer is comprised of nanotubes.

18. The material of claim 16, wherein the susceptor layer is comprised of nanoclay.

19. The material of claim 16, wherein the susceptor layer is comprised of graphene.

20. The material of claim 16, wherein the susceptor layer is comprised of nanoparticles.

21. The material of claim 16, wherein the susceptor layer is comprised of carbon fiber dust.

22. The material of claim 16, wherein the susceptor layer is comprised of carbon black.

23. A multilayered composite material comprising:
a fiber tape comprising fibers held together with a thermoplastic polymer matrix;
a first susceptor layer disposed on a first side of the fiber tape;
a first polymer surface layer disposed on the first susceptor layer;
a second susceptor layer disposed on a second side of the fiber tape; and
a second polymer surface layer disposed on the second susceptor layer.

24. The material of claim 23, wherein the fibers are continuous unidirectional fibers.
